(19) United States
(12) Patent Application Publication
(10) Pub. No.: US 2021/0118178 A1
(43) Pub. Date: Apr. 22, 2021

(54) TESTING APPARATUS, SYSTEM AND METHOD FOR TESTING

(71) Applicant: Carl Zeiss Industrielle Messetechnik GmbH, Oberkochen (DE)

(72) Inventor: Arnd Menschig, Boeblingen (DE)

(21) Appl. No.: 17/073,234

(22) Filed: Oct. 16, 2020

(30) Foreign Application Priority Data
Oct. 16, 2019 (DE) 10 2019 215 917.6

(51) Int. Cl. G06T 7/80; G01M 11/02; G01B 21/04; G01B 11/00

(52) U.S. Cl. CPC G06T 7/80; G01B 11/002; G01B 21/042; G01M 11/0264

(57) ABSTRACT

A testing apparatus for testing an object detection device, a system including such a testing apparatus, and a method for testing an object detection device are provided. The testing apparatus has or forms at least one test element. The testing apparatus includes at least one first communication device for data transmission between the testing apparatus and an external device. The testing apparatus includes at least one apparatus-specific storage device having apparatus-specific calibration data stored therein or for storing apparatus-specific calibration data. Stored calibration data are transmittable from the apparatus-specific storage device to the external device via the first communication device and apparatus-specific calibration data to be stored are transmittable to the apparatus-specific storage device via the first communication device.

### CROSS REFERENCE TO RELATED APPLICATIONS

This application claims priority to German patent application DE 10 2019 215 917.6, filed Oct. 16, 2019, the entire content of which is incorporated herein by reference.

### TECHNICAL FIELD

The disclosure relates to a testing apparatus for testing an object detection device, a system including such a testing apparatus and a method for testing an object detection device.

### BACKGROUND

The use of measuring devices, in particular coordinate measuring units, requires the measurement accuracy to be ensured. This is regularly accomplished by using what are known as calibration or test pieces, which are used for checking and adjusting states of such measuring devices.

Calibration certificates are known, which can contain not only fundamental information such as type of calibration item, type of calibration method, ambient and measurement conditions, place of calibration and information concerning measurement uncertainties but also further details. In summary, the calibration certificate thus contains calibration information or data such as for example a roundness shape-measurement divergence, which may be defined in accordance with DIN EN ISO 12181-1:2011-11-07 and in the guideline VDI/VDE 2617, sheet 2.2, as at July 2000.

In general, information recorded in the calibration certificate is transferred manually to an input mask retrievable for controlling the measuring device or the measurement sequence.

This process can necessitate being performed by specially trained personnel, since the applicable sequence requires specific knowledge. Furthermore, such a process may be erroneous, in particular if errors are made during the illustrated transfer.

Furthermore, test pieces are known that are made up of multiple single and individually calibrated individual test pieces. The calibration information illustrated above for each of these individual test pieces may then be available in the form of a calibration certificate, which further complicates the transfer process illustrated above.

Modular test pieces of this kind can include multiple calibration spheres, for example.

WO 2018/184865 A1 describes a calibration piece having a calibration feature for calibrating a sensor system and a method for calibrating the sensor system. The calibration piece includes a sensor for capturing data about the calibration piece, a data interface for transmitting the captured data to the sensor system to be calibrated and an electronic data memory for storing the data captured by the sensors.

### SUMMARY

A technical problem that arises is that of providing a testing apparatus for testing an object detection device, a system including the testing apparatus and a method for testing an object detection device that simplify the testing of an object detection device and render a test sequence less susceptible to error.

The solution to the technical problem is provided by a testing apparatus for testing an object detection device, a system including the testing apparatus, and a method for testing an object detection device, as described herein.

The proposal relates to a testing apparatus for testing and accuracy of an object detection device.

The object detection device may be in particular a measuring device. A measuring device may be in particular a coordinate measuring device or measuring unit. The measuring device can be used to determine dimensional variables of a measured object. In such a case, the testing apparatus can be used to test the measurement accuracy of the measuring device. Furthermore, the testing apparatus can be used to determine and set parameters of the measuring device.

The object detection device may alternatively be an image capture device or at least one, typically multiple, image capture device(s). The object detection device may be in particular a camera system. The at least one image capture device can be used to produce images of objects. In this instance the image capture device may be part of a measuring device. In this case, the image can be evaluated to determine dimensional variables. However, it is not necessary for the image capture device to be part of a measuring device and therefore to be used for measurement. As such, the image capture device can also be used just for producing images. In such a case the testing apparatus can be used to determine and set parameters of the at least one image capture device.

The testing apparatus has or forms at least one test element. The test element may be or can have a test feature.

The testing apparatus, in particular the at least one test element, can have predetermined properties, in particular predetermined geometric properties. These predetermined properties may be encoded by what are known as test or calibration data. It is therefore possible for test or calibration data to include for example geometric data, in particular dimensional variables of the testing apparatus, tolerances of the dimensional variables, a test or calibration date, information concerning measurement uncertainties and further information relevant to testing. Test or calibration data can also include an identifier of the test element. This identifier can be used/may have been used to associate the test or calibration data with a specific test element, advantageously in a manner that is unique worldwide.

The test element may be or can include in particular a test piece. An exemplary test piece may be for example a gauge ring or a test sphere. It is naturally also possible for test pieces having other geometric forms to be used, however.

Furthermore, the testing apparatus includes at least one first communication device for data transmission between the testing apparatus and an external device. The first communication device can include or form in particular a first communication interface for data transmission, in particular for bidirectional data transmission, between the testing apparatus and the external device. The first communication device or the form of the first communication device is illustrated in more detail below. In particular, the first communication device may be in a form, and/or the methods for data transmission may be designed, such that after data transmission stoppages no losses of data to be transmitted occur and/or the transmission is restored in quick time.

The data transmissions described in this disclosure can be performed in manipulation-proof, in particular encrypted, fashion or by using a blockchain-based method.

According to an aspect of the disclosure, the testing apparatus includes at least one apparatus-specific storage device having test or calibration data stored therein or for storing apparatus-specific test or calibration data. The term calibration data is used below for test and calibration data for the sake of clarity. The apparatus-specific calibration data in this instance encode the information illustrated above that is relevant to a test using the testing apparatus. In other words, the apparatus-specific calibration data can or may thus be stored or storable in the testing apparatus itself.

Furthermore, these calibration data are transmittable from the apparatus-specific storage device to the external device via the first communication device.

Furthermore, apparatus-specific calibration data to be stored are transmittable to the apparatus-specific storage device via the first communication device. These transmitted calibration data to be stored can then be stored in the apparatus-specific storage device.

The storage device can include or may be in the form of for example a random access memory (RAM) storage, a read-only memory (ROM) storage or a flash memory. In this instance, the stored data can in particular also be stored without a permanent power supply.

Calibration data, in particular including the resultant calibration data illustrated in more detail below, can be stored in encoded fashion together with descriptors, e.g., based on or according to the GS1 standard. The effect that can advantageously be achieved thereby is that the information is easily accessible, in particular independently of other information stored, e.g., in databases, in a manner that is comprehensible worldwide.

An external device may be in particular a superordinate device, e.g., a workstation or a personal computer (PC). Furthermore, the external device may also be the illustrated object detection device.

This advantageously results in apparatus-specific calibration data of the testing apparatus being able to be read easily and without error and provided for a testing operation. Manual, error- prone transfer of the calibration data from a calibration certificate associated with the apparatus can advantageously be dispensed with. In other words, a calibration certificate in digital form, which can also be referred to as a digital test certificate, can be provided by the testing apparatus. Furthermore, this allows the information to be retrieved and displayed to a user, e.g., an inspector as part of an audit.

Furthermore, an advantageous result is that apparatus-specific calibration data can easily be associated with the testing apparatus, namely by storing them in the apparatus-specific storage device. If for example properties of the testing apparatus change over its life, then new, in particular updated, calibration data can easily be stored in the apparatus-specific storage device, these new updated calibration data then being retrievable after this storage. The previously stored data are not necessarily overwritten in the process, which means that the historic trend in these data is also available and can be used by a device.

In particular, simple use of the provided testing apparatus in what are known as Industry 4.0 applications is therefore also rendered possible.

Storage of the calibration data in an apparatus-specific storage device of the testing apparatus furthermore advantageously results in data not needing to be retrieved from an external device, for example a server device of the Internet, since such a connection does not exist in some testing or measurement environments.

The illustrated testing may be in particular a calibration. In this case the testing apparatus can be referred to as a calibration apparatus, the test element can be referred to as a calibration element and the test piece can be referred to as a calibration piece. The calibration allows in particular operating parameters of the object detection device to be determined that are used, e.g., in a detection mode in order to detect, in particular to portray, an object or are used in a measurement mode in order to produce measurement results.

In a further exemplary embodiment, the testing apparatus includes at least one energy storage device. The energy storage device may be in particular in the form of a storage battery. The energy storage device may therefore be a rechargeable energy storage device. The energy storage device in this instance can provide power for operating the testing apparatus, in particular the first communication device and the storage device.

It is possible for the testing apparatus to include at least one power supply interface, power being transmittable to the energy storage device from outside via this power supply interface. It is alternatively conceivable for power to be transmittable from the energy storage device to an external system via the power supply interface. The power supply interface may be in the form of an interface for wired or wireless power transmission. As such, the power supply interface can allow for example inductive power transmission. The presence of the energy storage device advantageously results in a reliable power supply for the testing apparatus or elements of the testing apparatus. The energy storage device may in this instance be configured to ensure the power supply for the elements of the testing apparatus that require power at least for one test cycle while using the testing apparatus. As such, the energy storage device can in particular be configured such that it needs to be charged only once a week, once a month or once a year.

If the energy storage device has no charge, e.g., a charge that is lower than a predetermined threshold value, corresponding user information can be produced.

In order to present such user information, the testing apparatus can include an information output device. This may be, e.g., in the form of a device for outputting visual information, e.g., in the form of a display device. Such a device may also be in the form of a device for outputting audible information.

Alternatively or cumulatively, the testing apparatus includes at least one evaluation device. An evaluation device may be for example in the form of or can include a PC or microcontroller or an integrated circuit. The at least one evaluation device in this instance may be connected for example to the first communication device and/or to the apparatus-specific storage device for the purpose of supplying data and/or signals. The presence of the at least one evaluation device advantageously allows the performance of signal processing processes, for example for processing output signals of the detection device, and/or processes illustrated in more detail below for determining resultant calibration data.

Alternatively or cumulatively, the testing apparatus includes at least one capture device for capturing a physical variable. Such a capture device may be a sensor, for example. In particular, the capture device may be in the form of a temperature sensor. A temperature sensor in this instance may be configured for example to capture a temperature of the testing apparatus or of a section thereof. Alternatively or cumulatively, further temperature sensors for capturing an ambient temperature of the testing apparatus or of a further or multiple further section(s) of the testing apparatus may be present. The presence of a capture device advantageously allows the capturable physical variables to be taken into consideration when determining the test data and/or or during testing with the testing apparatus. By way of example, the output signals of the capture device can be transmitted via the first communication device to a testing measuring device, which can then perform the test on the basis of these output signals. It is therefore possible to take into consideration, e.g., a temperature during the test. The output signals transmitted in this manner can also be taken as a basis for determining and testing a quality of the measurement result.

If multiple capture devices are present, the output signals can also be fused for this purpose.

The capture device in this instance may be connected to the first communication device and/or the apparatus-specific storage device and/or or the evaluation device for the purpose of supplying signals and/or data.

Furthermore alternatively or cumulatively, the testing apparatus includes an information output device. This has already been illustrated above. As an alternative or in addition to the exemplary embodiments illustrated above, the information output device can also transmit information to an external device on a signal and/or data basis, e.g., via the illustrated first communication device or by e-mail.

The illustrated devices in this instance may be in the form of modules of the testing apparatus or can form a part of a module, wherein a module can include precisely one of the illustrated devices or multiple instances of the illustrated devices. Modules of the testing apparatus are illustrated in more detail below.

In a further exemplary embodiment, the testing apparatus includes at least one mounting device. The mounting device may be in particular in the form of a workpiece mount. In this instance the testing apparatus may be mechanically attached to/upon the mounting device, typically detachably. If the testing apparatus is attached detachably, it may be in particular attachable to the mounting device reproducibly in an exact bearing.

The mounting device can include a communication device for data transmission between the testing apparatus and the mounting device and also a communication device for data transmission between the mounting device and the external device illustrated above. This communication device can include or may form for example an interface for the illustrated data transmission(s). As such, it is for example conceivable for data to be transmitted from the testing apparatus to the external device (and vice versa) via the mounting device.

Furthermore, the mounting device can include a power supply interface, wherein the power supply interface of the testing apparatus can be connected to the power supply interface of the mounting device. Furthermore, the power supply interface of the mounting device may be connectable to an existing power supply device, for example one in the supply grid. As such, it is for example conceivable for power to be transmitted from a power supply device to the testing apparatus (and vice versa) via the mounting device.

It is furthermore possible for the test element of the testing apparatus to be attached to the mounting device. The energy storage device and/or the evaluation device and/or the capture device for capturing a physical variable may also be attached to/upon the mounting device. In this instance, signal and/or data connections and/or connections for the supply of power between the testing apparatus and the devices belonging to the testing apparatus may be routed via the mounting device.

The mounting device can include an attachment interface for attaching the testing apparatus, a device of the testing apparatus and/or a module of the testing apparatus. The attachment interface in this instance can allow reproducible positioning of the testing apparatus, the device or the module relative to the mounting device. By way of example, the attachment interface can include or form alignment pins or similar means. Such an attachment interface may be in particular in a form such that reproducible attaching of the testing apparatus, a device of the checking apparatus and/or a module of the testing apparatus to the mounting device in an exact bearing is rendered possible.

Furthermore, the mounting device can include or form an attachment interface for attaching the mounting device to a retaining structure, for example a measuring table. Such an attachment interface may be in particular in a form such that reproducible attachment of the mounting device to the retaining structure in an exact bearing is rendered possible. The attachment interface in this instance can include in particular what is known as a three-point bearing or may be in the form of a three-point bearing or else in the form of a zero-point clamping system. This advantageously allows reproducible positioning of the mounting device and hence also of a testing apparatus attached to the mounting device in the measurement area of a measuring device or in the detection area of an object detection device.

In a further exemplary embodiment, the first communication device includes or is in the form of a device for wireless data transmission. Such a device can include in particular an antenna structure for sending and/or receiving data.

A device for data transmission may be in particular a device for radio-based data transmission. Alternatively or cumulatively, a device for wireless data transmission may also be a device for radio frequency (RF)-based data transmission, as are used, e.g., in radio-frequency identification (RFID) systems. The first communication device can naturally also allow further wireless data transmissions. In particular, a device for wireless data transmission can include or form devices for wireless data transmission in different frequency ranges. A wireless data transmission may also be an optical data transmission, in particular with light waves.

Alternatively or cumulatively, the first communication device includes a device for wired data transmission. Such a device for wired data transmission can include a serial interface, for example. It is also possible for the device for wired data transmission to include a plug-connection interface.

This advantageously results in simple and reliable data transmission between the apparatus-specific storage device and an external device.

In a further exemplary embodiment, a device for wireless data transmission includes at least one antenna structure, wherein this antenna structure is configured both for data transmission in a first frequency range, for example for radio-based data transmission, and for data transmission in a further frequency range, for example for the RF-based data transmission of RFID technology. The first frequency range may differ from the further range in this case. In particular, at least one frequency or all of the frequencies of the first frequency range may differ from one or all of the frequencies of the further frequency range. Typically, however, the first frequency range corresponds to the further frequency range.

This advantageously results in a form of the testing apparatus that reduces production costs and a form that reduces installation space requirements, with reliable data transmission via multiple data transmission paths being rendered possible at the same time.

In a further exemplary embodiment, the testing apparatus includes at least one base body. The base body may be in particular a base body of the main module illustrated in more detail below. Furthermore, the apparatus-specific storage device is arranged in the base body. In particular, the base body can form or at least partly include a cavity, wherein the apparatus-specific storage device is arranged in the cavity. As such, the apparatus-specific storage device may be arranged for example in a spatial area, at least part of which is comprised by the base body.

The base body in this instance can have or form the test element illustrated above. This advantageously results in a form of the testing apparatus that reduces installation space requirements, since the arrangement of the storage device produces no additional installation space requirement.

In a further exemplary embodiment, an antenna structure at least partly covers the apparatus-specific storage device.

It is possible for the antenna structure to be arranged on a printed circuit board or to be formed by a printed circuit board. In this case an envelope of the antenna structure can include all or at least part of the envelope of the storage device in a common projection plane, the common projection plane being able to be arranged perpendicularly with respect to the surface of the conductor structure.

The apparatus-specific storage device may also be formed by a printed circuit board or arranged on a printed circuit board. In this instance, the printed circuit board having the apparatus-specific storage device may be different than the printed circuit board having the antenna structure.

The fact that the antenna structure covers the apparatus-specific storage device can in particular alternatively mean that a spatial area in which the apparatus-specific storage device is arranged is at least partly bounded by the antenna structure. By way of example, the antenna structure or the printed circuit board can form a wall section of the spatial area. It is also conceivable for the basic body and the antenna structure, or the printed circuit board having the antenna structure, to include the spatial area having the apparatus-specific storage device arranged therein. In other words, the antenna structure can form a wall element for bounding the illustrated cavity. This advantageously results in reliable data transmission between the apparatus-specific storage device and an external device via the antenna structure, the reduction in the installation space requirements that was illustrated above being ensured at the same time.

In a further exemplary embodiment, the testing apparatus includes at least two modules, wherein one module includes the at least one apparatus-specific storage device. The module that includes the at least one apparatus-specific storage device can be referred to as a main module. The at least one further module can be referred to as a submodule. As illustrated above, the described devices may be in the form of a module or may be comprised by a module.

Different modules of the testing apparatus may be mechanically connected to one another, in particular detachably. As such, e.g., one module may be attached to another module. In this case, it is possible for different modules to be mechanically connected to one another directly.

Alternatively, different modules may be arranged at a predetermined distance apart from one another, for example on/upon the mounting device, illustrated above, of the testing apparatus. In this case the modules are not attached to one another.

Furthermore, different modules may be connected to one another for the purpose of supplying data and/or signals. To this end, the different modules can include appropriate communication devices and/or interfaces. These communication devices can also be referred to as module communication devices. The module communication devices in this instance may be configured for wired and/or wireless data transmission.

It is possible for the illustrated first communication device to form a module communication device. However, it is also possible for the first communication device not to be used for data transmission between modules and therefore to be different than a module communication device.

Furthermore, different modules may be connected to one another for the purpose of supplying power, for example wirelessly or by wire.

In particular it is possible for a module to have or form an interface for mechanically attaching it to another module. Alternatively or cumulatively, a module can have or form an interface for mechanically attaching it to the illustrated mounting device. The data transmission for module communication or the power transmission between different modules in this instance can take place directly, in particular via appropriate interfaces, or via at least one connecting element, for example the mounting device illustrated above. The communication devices of the modules, in particular of the submodules, in this instance may be unidirectional communication devices, that is to say communication devices that allow data transmission from the module to another module, in particular the main module illustrated above, but not vice versa. Alternatively, a communication device of one module, in particular of the main module, may be a bidirectional communication device.

The described modular form of the testing apparatus advantageously results in an application-specific testing apparatus being able to be produced in a flexible manner, the advantages illustrated above in regard to the availability of calibration data and the flexibility for positioning the modules being retained at the same time.

In particular, in the case of a testing apparatus consisting of multiple modules, the resultant calibration data can be determined from module-specific calibration data and stored in the apparatus-specific storage device.

In a further exemplary embodiment, one module, in particular a submodule, includes a module storage device having module-specific calibration data stored therein and/or having module identifier data stored therein. If the module is a submodule, the module storage device can also be referred to as a submodule storage device.

These module identifier data can encode a unique identifier of the module. Such an identifier may be encoded, e.g., in the form of a QR code or an RFID mounted on a module.

It is possible for the main module also to include a module storage device. The module storage device of the main module in this instance may be the apparatus-specific storage device illustrated above or another storage device.

Module identifier data can in particular allow unique identification of a module. This module identifier can have the module-specific calibration data associated with it. These and the applicable association may be stored for example in an external storage device, for example in a database. If the module identifier data are known, the module-specific calibration data associated therewith can be retrieved from the external storage device.

It is furthermore possible for one submodule also to include a communication device for data transmission between the submodule and an external device, wherein module-specific calibration data are transmittable from the (sub)module storage device to the external device via this communication device or wherein calibration data to be stored are transmittable to the module-specific storage device via the communication means of the submodule.

In this case, it is possible for example for an external device to read the (sub)module-specific calibration data of all of the (sub)modules of the testing apparatus from the applicable (sub)module-specific storage devices and then to take these (sub)module-specific calibration data as a basis for determining resultant calibration data that can then in turn be stored in the apparatus-specific storage device.

Alternatively, the (sub)module-specific calibration data can be transmitted to the main module with a module communication and then read by the external device via the first communication device of the testing apparatus, with resultant calibration data then being determined that can then likewise in turn be stored in the apparatus-specific storage device.

The storage of module-specific calibration data and/or identifier data advantageously results in resultant calibration data of a testing apparatus that includes the module being able to be determined easily and in quick time.

In a further exemplary embodiment, at least one module has or forms at least one attachment device for attaching a further module. This attachment device may be arranged and/or in a form in particular such that a relative position between the modules is set reproducibly with a desired accuracy when the modules are attached to one another. An attachment device can include for example a thread (internal or external thread). Furthermore, an attachment device can include elements for producing a clamp connection, a latch connection and further types of connection.

It is possible for one module to have or form multiple attachment devices for attaching multiple further modules. These attachment devices can be used to attach further modules in different relative bearings.

It is possible for one module to have or form at least one device for detecting an occupied state of an attachment device of a module.

The device for detecting the occupied state, in particular evaluation of an output signal of this device, allows detection that a further module is attached to a specific attachment device. A bearing, that is to say a position and/or orientation, of the attachment device in a module-specific coordinate system, in particular a coordinate system fixed to the module, may be known in advance in this instance, for example as a result of an appropriate measurement of the module or on the basis of design data of the module. If a further module is attached to the module with the attachment device, then this previously known bearing of the attachment device and previously known geometric information about the attached further module can be taken as a basis for determining resultant geometric information and resultant calibration data for the module as a whole. This resultant information can also be referred to as apparatus-specific configuration information.

The presence of an attachment device for attaching a further module advantageously allows simple production of an overall module consisting of multiple modules.

In a further exemplary embodiment, at least one module includes at least one communication device for data and/or signal transmission between the module and at least one further module. This data and/or signal transmission can also be referred to as module communication and has already been illustrated above.

Data transmission from the submodule to the main module can be a direct data transmission, i.e., without any intermediate module or element being involved. Data transmission from the submodule to the main module can, however, alternatively be an indirect data transmission by which data is transmitted via at least one intermediate module or element, in particular via the aforementioned external device. In the first case, data stored in the module storage device of a submodule can be transmitted directly to the module comprising the apparatus-specific storage device. In the latter case, data stored in the module storage device of a submodule can be transmitted to the external device, wherein said data is then transmitted from the external device to the apparatus-specific storage device. Also, data can be transmitted via data communication means integrated or being part of the mounting device. Data transmission can, e.g., be performed using a bus system, e.g., a data bus.

In particular, the module-specific communication device allows data transmission of module-specific calibration data from the submodule to the main module, these calibration data then being able to be stored in the apparatus-specific storage device. In this instance, the module-specific calibration data can be stored in a manner associated with the submodule, in particular an identifier of the submodule.

Alternatively or cumulatively, the module-specific calibration data can be transmitted to the evaluation device of the testing apparatus or to an apparatus-external evaluation device, the evaluation device then taking the module-specific calibration data as a basis for determining resultant calibration data of the testing apparatus with these modules. Resultant calibration data in this instance can also include a testing-apparatus-specific identifier.

In this regard, it is also possible for information about a relative bearing between the modules to be determined and taken into consideration for determining the resultant calibration data, for example with the device illustrated above for detecting an occupied state, with geometric or optical measurement or with a user input, which is explained in more detail below.

The resultant calibration data determined in this way can then be stored in the apparatus-specific storage device.

This advantageously results in simple determination and provision of resultant calibration data. Furthermore, the communication devices advantageously allow simple transmission of information between modules.

In a further exemplary embodiment, one module includes at least one interface for power transmission to the module. This and corresponding advantages have already been illustrated above.

In a further exemplary embodiment, one submodule is a test element module. A test element module in this instance can have or form a test element. This test element can have associated test-element-specific calibration data illustrated above. These calibration data can correspond to the module-specific calibration data likewise illustrated above.

Alternatively, one submodule is an energy storage module. An energy storage module in this instance can include the energy storage device illustrated above.

As a further alternative, one submodule is a communication module. The communication module in this instance can include the module-specific communication device illustrated above or parts thereof. Furthermore, a communication module can also comprise the first communication device illustrated above or parts thereof, for example an antenna structure.

As a further alternative, one submodule is an evaluation module. The evaluation module in this instance can include the evaluation device illustrated above.

As a further alternative, one submodule is a capture module. A capture module in this instance can include the capture device illustrated above for capturing a physical variable.

It is possible for different submodules to be directly attached to the main module illustrated above. Alternatively, it is also possible for different submodules, or an energy storage module and/or a communication module and/or an evaluation module and/or a capture module, to be arranged physically apart from the main module, for example attached to the mounting device illustrated above. In particular, it is conceivable for one or more submodules in the form of test element modules to be attached to the main module illustrated above, wherein an energy storage module, a communication module and a capture module are arranged physically apart from this main module.

The modules, in particular a communication module, an energy storage module or an information output module, may be in particular embodied as certified modules. If such a module is used, such a certified module can advantageously be used to provide a testing apparatus including multiple modules that does not need to be individually certified. It is therefore possible to provide multiple product variants without additional certification outlay. This advantageously reduces production outlay.

It is possible for different modules to each include a device for capturing a physical variable. By way of example, both the main module and at least one submodule can include such a device, which may be in particular in the form of a temperature sensor.

This advantageously results in simple production of a testing apparatus having desired properties.

A system is furthermore provided, wherein the system includes a testing apparatus in accordance with one of the exemplary embodiments described in this disclosure and at least one evaluation device. Resultant calibration data of the testing apparatus are determinable with the evaluation device on the basis of module-specific calibration data. The evaluation device in this instance may be in particular an apparatus-external evaluation device. In particular, the evaluation device may be an evaluation device of the external device illustrated above, that is to say for example an evaluation device of a coordinate measuring unit or an evaluation device of a superordinate system.

Calibration data stored in the apparatus-specific storage device are transmittable to the evaluation device in this instance. Furthermore, apparatus-specific calibration data to be stored are transmittable from the evaluation device to the apparatus-specific storage device and storable therein.

In this instance, it is possible for module-specific calibration data to be transmitted from submodules to the main module and stored in the apparatus-specific storage device, the total volume of all of the module-specific calibration data then being transmitted to the evaluation device. These calibration data can then be taken as a basis for determining resultant calibration data of the testing apparatus including the multiple modules. These resultant calibration data can then be transmitted to the apparatus-specific storage device again and stored therein.

Alternatively, it is possible for module-specific calibration data to be transmitted from each module to the evaluation device, the module-specific calibration data transmitted in this manner then being taken as a basis for determining resultant calibration data, these then being transmitted to the apparatus-specific storage device and stored therein.

It is additionally possible for resultant calibration data to also be determined on the basis of a user input. A user input allows for example information about a relative bearing between different modules of the testing apparatus to be provided.

Information about the relative bearing can also be produced with evaluation of output signals from devices for detecting the relative bearing or with a measurement of the testing apparatus, in particular an optical measurement, however. This advantageously results in simple production of a testing apparatus including multiple different modules, in particular test element modules, wherein resultant calibration data of this compiled testing apparatus can easily be determined and provided.

In a further exemplary embodiment, the system includes at least one human machine interface (HMI).

The HMI in this instance can include at least one output device for outputting information to a user. Such an output device may be, e.g., in the form of a display device. A display device may be for example in the form of a screen or can include a screen. An output device can naturally also produce information in a different visual manner or in a nonvisual manner, for example audibly and/or haptically.

Alternatively or cumulatively, the HMI can include an input device for user inputs. Such an input device can be provided for example in the form of a keypad, in particular also in the form of what is known as a touchpad. Input devices in other forms, e.g., for input by voice, are naturally also conceivable, however.

By way of example, the HMI may be provided by a PC, in particular what is known as a workstation, or as a portable computer device, for example as a tablet PC.

The HMI in this instance may be connected to the illustrated evaluation device for the purpose of supplying data and/or signals. The HMI may also be connected to the apparatus-specific storage device for the purpose of supplying data and/or signals, in particular via the first communication device illustrated above.

The system can include (further) functional modules that are provided by the evaluation device illustrated above or by other computing devices.

A functional module can be provided as a software container, e.g., as a docker container. Such a container in this instance can contain software for performing the functions of the functional module and a file system. It is also possible for functional modules of this kind having a container management system to be provided as industrial apps on an IoT operating system, e.g., using web technologies.

A functional module may be for example a quick response (QR) code reading device. A further functional module may be for example an RFID reading device. A further functional module may be for example a computer-aided design (CAD)-based geometric data generating module. A further functional module may be a database module. A further functional module may be a calibration data generating module. A further functional module may be an RFID writing device.

The different functional modules in this instance may be connected to one another for the purpose of supplying signals and/or data, for example via a bus system, in particular an Ethernet-based bus. A data transmission between the different modules can typically comply with what is known as the “publish & subscribe” concept and take place in accordance with a predetermined communication protocol, for example the message queuing telemetry transport (MQTT) protocol.

This advantageously results in simple reading of calibration data and generation of resultant calibration data for a testing apparatus produced on an application-specific basis, for example.

A program is also described that, when executed on or by a computer or an evaluation device, causes the computer to carry out one, several or all of the steps of the method set out in this disclosure for generating resultant calibration data. Alternatively or cumulatively, a program storage medium or computer program product, on or in which the program is stored, in particular in a non-temporary, e.g., permanent, form, is described. Alternatively or cumulatively, a computer that includes this program storage medium is described. Furthermore, alternatively or cumulatively, a signal is described, for example a digital signal, that encodes information items representing the program and that includes encoding means suitable for performing one, several or all of the steps of the method set out in this disclosure for generating resultant calibration data. The signal can be a physical signal, for example an electrical signal, that in particular is generated by technical means or by machine. The program can also cause the computer to carry out the determination of resultant calibration data.

Furthermore, the method for generating resultant calibration data may be a computer-implemented method. As such, for example, one, a plurality or all of the steps of the method can be carried out by a computer. One exemplary embodiment of the computer-implemented method is the use of the computer for carrying out a data processing method. For example, the computer can include at least one computing device, in particular a processor, and for example at least one storage device, in order to process the data, in particular by technical means, for example electronically and/or optically. A computer in this instance may be any kind of data processing device. A processor may be a semiconductor-based processor.

A method for testing an object detection device is furthermore provided. The method can be performed in particular using a testing apparatus according to one of the exemplary embodiments described in this disclosure or a system described in this disclosure. In this instance, calibration data are retrieved from the apparatus-specific storage device of the testing apparatus, for example by the system to be tested, in particular the image capture device to be tested or the measuring device to be tested. This means that it is therefore possible for the calibration data of the testing apparatus that are stored in the apparatus-specific storage device to be transmitted to the system to be tested, in particular via the first communication device. Thereafter, the testing is performed on the basis of these retrieved calibration data. In particular, a measurement accuracy of the measuring device can be determined on the basis of the retrieved calibration data. The method can also be used to calibrate the measuring device, wherein the retrieved calibration data are taken as a basis for determining, e.g., operating parameters of the measuring device for a measurement mode on the basis of the retrieved calibration data.

All in all, the advantageous result is simple and accurate testing, with in particular errors during the provision of the calibration data being reduced.

In a further exemplary embodiment, resultant calibration data are determined and are stored in the apparatus-specific storage device.

The resultant calibration data in this instance can be determined in particular by the evaluation device, illustrated above, of the testing apparatus or the evaluation device, illustrated above, of a system. The resultant calibration data in this instance can be determined on the basis of (sub)module-specific calibration data and, if necessary, on the basis of information about a relative bearing between different (sub)modules of the testing apparatus.

### BRIEF DESCRIPTION OF THE DRAWINGS

The disclosure will now be described with reference to the drawings wherein:

FIG. 1 shows a schematic block diagram of a testing apparatus and an external device according to an exemplary embodiment of the disclosure,

FIG. 2 shows a schematic block diagram of a testing apparatus and an external device according to a further exemplary embodiment of the disclosure,

FIG. 3 shows a schematic block diagram of a testing apparatus according to a further exemplary embodiment of the disclosure,

FIG. 4 shows a schematic sectional view of a testing apparatus according to an exemplary embodiment of the disclosure,

FIG. 5 shows a schematic plan view of a testing apparatus according to an exemplary embodiment of the disclosure,

FIG. 6 shows a schematic flowchart of a method for testing a measuring device according to an exemplary embodiment of the disclosure,

FIG. 7 shows a schematic flowchart of a testing method according a further exemplary embodiment of the disclosure,

FIG. 8 shows a schematic function diagram of a system including a testing apparatus and an evaluation device,

FIG. 9A shows a perspective view of a testing apparatus according to an exemplary embodiment of the disclosure,

FIG. 9B shows a perspective view of a testing apparatus according to an exemplary embodiment of the disclosure, and

FIG. 9C shows a perspective view of a testing apparatus according to an exemplary embodiment of the disclosure.

### DESCRIPTION OF EXEMPLARY EMBODIMENTS

Identical reference signs hereinafter denote elements having identical or similar technical features.

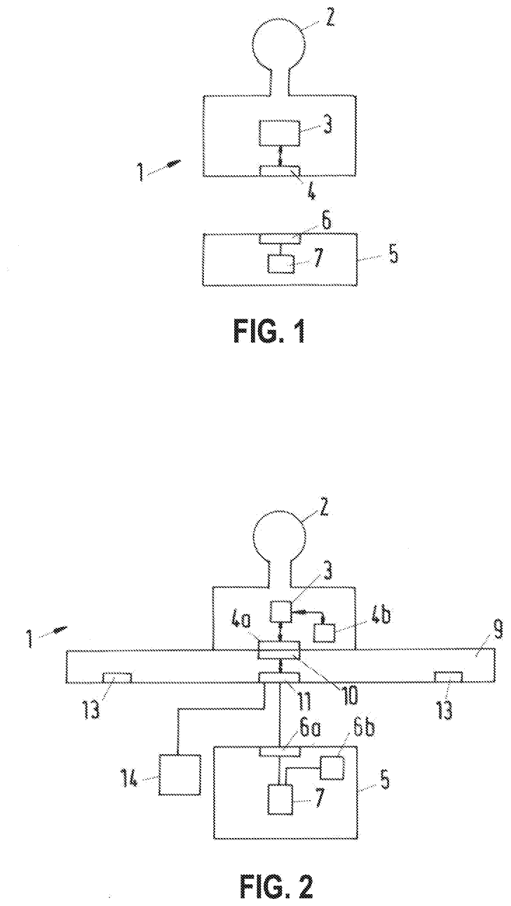

FIG. 1 shows a schematic block diagram of a testing apparatus 1 according to an exemplary embodiment of the disclosure. The testing apparatus 1 is used for testing an object detection device, in particular a camera system, or a measuring device (not depicted). The testing apparatus 1 forms a spherical test element 2.

The depiction furthermore shows that the testing apparatus 1 includes an apparatus-specific storage device 3 having apparatus-specific test or calibration data stored therein or storable therein. The storage device 3 in this instance may be in the form of a RAM storage device, ROM storage device, in particular in the form of an EEPROM storage device, or in the form of a flash storage device.

The depiction furthermore shows a first communication device 4 for data transmission between the testing apparatus 1 and an external device 5, which can include or form a communication interface. The depiction furthermore shows that the external device 5 likewise has a communication device 6, which can likewise include or form a communication interface, and an evaluation device 7, wherein the evaluation device 7 may be in the form of or can include for example a microcontroller or an integrated circuit.

The apparatus-specific test or calibration data stored in the apparatus-specific storage device 3 are transmittable to the evaluation device 7 of the external device 5 via the communication devices 4, 6. The communication devices 4, 6 in this instance may be configured for wired or cabled data transmission. Alternatively, the communication devices 4, 6 may also be configured for wireless data transmission, for example for wireless data transmission by radio, e.g., in accordance with the 5G standard, or wireless local area network (WLAN) or by Bluetooth or by RFID. The communication devices 4, 6 may naturally also be configured such that both wired and wireless data transmission is possible.

Furthermore, apparatus-specific test and calibration data to be stored are transmittable from the external device 5 to the apparatus-specific storage device 3 via the communication interfaces 4, 6 and are then storable in said apparatus-specific storage device.

By way of example, the evaluation device 7 can determine resultant test or calibration data, which are illustrated in more detail below, of the testing apparatus 1 and then transmit them to the apparatus-specific storage device 3 via the communication interfaces 4, 6, and said data can then be stored in said apparatus-specific storage device.

The apparatus-specific storage device in this instance is connected to the first communication device 4 for the purpose of supplying signals and/or data, this connection allowing bidirectional data transmission between the apparatus-specific storage device 3 and the first communication device 4.

It is conceivable for the external device 5 to be a coordinate measuring device that, for testing purposes, in particular for calibration purposes, retrieves the calibration data stored in the apparatus-specific storage device 3 and then performs the testing, in particular the calibration, on the basis of these retrieved calibration data.

It is also conceivable for the external device 5 to be a superordinate system, for example a device for programming the testing apparatus 1 that—as illustrated in more detail below—generates test or calibration data to be stored and then transmits them to the apparatus-specific storage device 3 via the communication devices 4, 6.

FIG. 2 shows a schematic block diagram of a testing apparatus 1 and an external device 5 according to a further exemplary embodiment. The depiction shows that the testing apparatus 1 has a test element 2 and includes an apparatus-specific storage device 3. The depiction furthermore shows that the testing apparatus 1 includes a first communication interface 4a for wired data transmission and a further communication interface 4b for wireless data transmission. The first and further communication interfaces 4a, 4b in this instance may both be parts of the first communication device 4 for data transmission between the testing apparatus 1 and the external device 5.

The depiction furthermore shows that the testing apparatus 1 includes a mounting device 9 in the form of a mounting plate. The mounting device 9 in this instance likewise includes communication interfaces 10, 11 that allow wired data transmission. In this instance, a first communication interface 10 of the mounting device 9 is connected to a communication interface 4a of the testing apparatus 1 for the purpose of supplying data and/or signals. Furthermore, a further communication interface 11 of the mounting device 9 is connected to a communication interface 6a of the external device 5 for the purpose of supplying data and/or signals. The communication interfaces 6a, 11, 10, and 4a in this instance can be used to transmit data from the external device 5 to the testing apparatus 1 in wired fashion. It is likewise possible for data to be transmitted from the testing apparatus 1 to the external device 5 via the communication interfaces 4a, 10, 11, and 6a.

The external device 5 can have a further communication interface 6b for wireless data transmission in addition or as an alternative to the first communication interface 6a, both communication interfaces 6a, 6b being able to be part of the communication device 6 of the external device 5. In this instance, a data transmission between the external device 5 and the testing apparatus 1 can take place via the further communication interfaces 4b, 6b for wireless data transmission. These interfaces 6b, 4b in this instance can for example each include at least one antenna structure 28 (see FIG. 4).

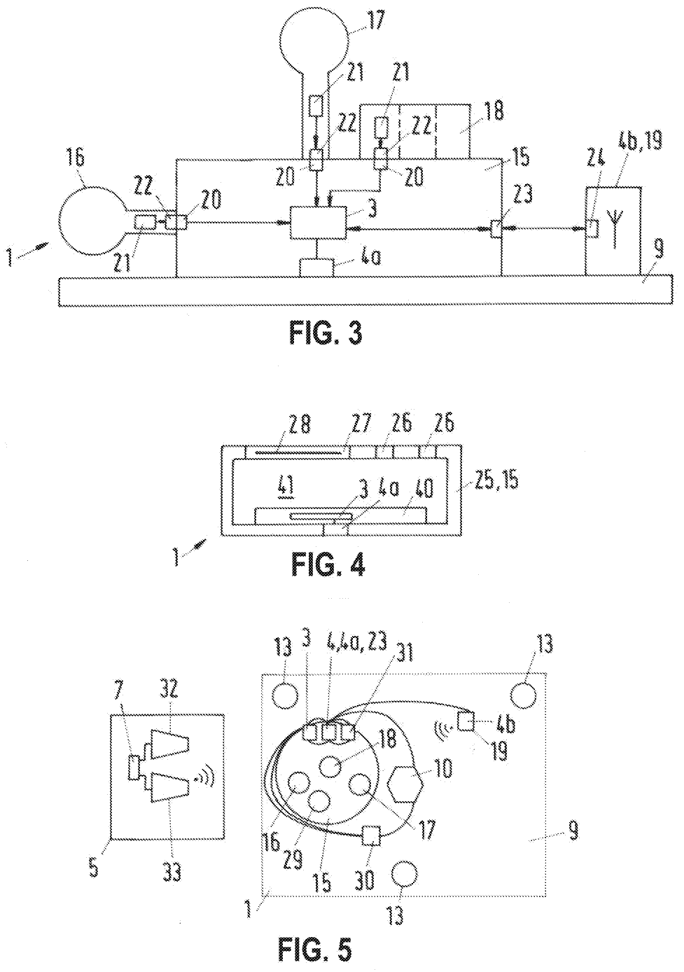

The mounting device 9 can have or form attachment interfaces 13 for repeatably attaching the mounting device 9 in a measurement area of a coordinate measuring device, for example on a measuring table of the coordinate measuring device, in an exact bearing. The mounting device 9 can likewise have attachment interfaces (not depicted) for repeatably attaching the testing apparatus 1 or at least one module 15, 16, 17, 18, 19, 29, and 30 (see, e.g., FIG. 3) to/upon the mounting device 9 in an exact position. The testing apparatus 1 can therefore be arranged in the measurement area of the coordinate measuring device repeatably and in an exact position.

The depiction furthermore shows an external power supply device 14, which may be in the form of an energy storage device or power supply grid, for example. The depiction furthermore shows that the communication interfaces 10, 11 of the mounting device 9 and the communication interface 4a of the testing apparatus 1 can also be used to supply power to the testing apparatus 1 and in particular to the components thereof, for example the apparatus-specific storage device 3 and the further communication interface 6b. FIG. 2 depicts that power is supplied in wired fashion, for example via appropriate lines.

It is naturally also conceivable to provide wireless power transmission, for example inductive power transmission, from an external power supply device to the testing apparatus 1.

In this case, the testing apparatus 1 can include for example a secondary winding structure for receiving an electromagnetic alternating field, the electromagnetic alternating field being generated by a primary winding structure of the external power supply device. Furthermore, on receiving the electromagnetic alternating field, the secondary winding structure can generate an AC voltage by induction, said voltage then being used to supply power to the elements. The generated AC voltage can also be rectified and used to supply power to the testing apparatus 1.

It is also possible for the secondary winding structure to form an antenna structure 28 for data transmission. However, it is naturally also possible for the antenna structure in the secondary winding structure to be in the form of separate elements.

FIG. 3 shows a schematic block diagram of a testing apparatus 1 according to a further exemplary embodiment of the disclosure. The depiction shows a mounting device 9, wherein a main module 15 of the testing apparatus 1 is attached upon/to the mounting device 9. The depiction furthermore shows that in addition to the main module the testing apparatus 1 includes a first submodule 16, which is in the form of a test element module. The first submodule 16 in this instance forms a spherical test element. The testing apparatus 1 likewise includes a second submodule 17, which is likewise in the form of a spherical test element module. The testing apparatus 1 also includes a third submodule 18, which is in the form of a gauge ring test element module. The depiction shows that test element submodules are attached to the main module 15 at different positions and with different orientations relative to said main module.

The testing apparatus 1 likewise includes a communication module 19 for wireless data transmission.

The main module 15 includes the apparatus-specific storage device 3 and the first communication interface 4a, already illustrated with reference to FIG. 1, of the first communication device 4 of the testing apparatus 1.

The main module 15 also includes unidirectional module communication interfaces 20 for transmitting data from the submodules 16, 17, and 18 to the apparatus-specific storage device 3.

The test element modules 16, 17, and 18 each include a module-specific storage device 21, these storage devices 21 storing module-specific test or calibration data. These test element modules 16, 17, and 18 likewise each include unidirectional module communication interfaces 22 that can be used to transmit data from the module-specific storage devices 21 to the apparatus-specific storage device 3 of the main module 15. The depiction shows that the module-specific storage devices 21 of the test element modules 16, 17, and 18 and the unidirectional module communication interfaces 20, 22 are designed to allow unidirectional data transmission of data from the module-specific storage devices 21 to the apparatus-specific storage device 3.

The depiction does not show attachment interfaces of the main module 15 and the test element modules 16, 17, and 18, with which the test element modules 16, 17, and 18 can be repeatedly attached to the main module 15 in an exact bearing.

The depiction furthermore shows that the communication module 19 is not attached directly to the main module 15, but rather is arranged physically apart from the main module 15 on the mounting device 9. The depiction schematically shows a data transmission between the main module 15 and the communication module 19, which may be a bidirectional data transmission. To this end, the main module 15 and the communication module 19 each comprise a bidirectional module communication interface 23, 24. The communication module 19 in this instance includes the further communication interface 4b, depicted in FIG. 2, of the first communication device 4 for wireless data transmission.

FIG. 4 shows a schematic sectional view of a testing apparatus 1 according to an exemplary embodiment of the disclosure. It depicts a housing 25 of the testing apparatus 1 and attachment interfaces 26 for attaching submodules 16, 17, and 18 of the testing apparatus 1, in particular test element modules 16, 17, and 18. The housing 25 in this instance may be a housing of the main module 15 (see FIG. 3). The depiction furthermore shows that the testing apparatus 1 includes a first printed circuit board 40, which is arranged in an interior 41 of the housing 25. The apparatus-specific storage device 3 is arranged on or in the printed circuit board 40. The depiction furthermore shows a second printed circuit board 27 of the testing apparatus 1, wherein an antenna structure 28 for wireless data transmission is arranged on or in the further printed circuit board 27. The depiction in this instance shows that the further printed circuit board 27 covers the first printed circuit board 40. In particular, the further printed circuit board 27 forms a section of a top or cover of the housing 25, this allowing the interior 41 of the housing 25 to be covered. The depiction likewise shows a first communication interface 4a for wired data transmission, which has already been illustrated with reference to the embodiment depicted in FIG. 1.

It is also conceivable for the first printed circuit board 40 and the second printed circuit board 27 to be in the form of a common printed circuit board. In this case, the antenna structure 28 may be arranged on a top of the common printed circuit board, which, e.g., forms part of an outer side of the housing 25, and the apparatus-specific storage device 3 may be arranged under this top, e.g., on an underside.

FIG. 5 shows a schematic plan view of a testing apparatus 1 according to an exemplary embodiment of the disclosure. The testing apparatus 1 includes a mounting device 9 having attachment interfaces 13 for attaching the mounting device 9 in a measurement area of a coordinate measuring unit. Attachment interfaces 13 can form in particular elements of a three-point mounting of the mounting device 9 on a measuring table or in the measurement area of the coordinate measuring device.

The depiction furthermore shows that the testing apparatus 1 includes a main module 15, wherein a first submodule 16, a second submodule 18, a third submodule 17, and a fourth submodule 29 are mechanically attached to the main module 15. These submodules 16, 17, 18, and 29 in this instance may be test element modules that each have or form at least one test element or features.

The depiction furthermore shows that the main module 15 includes the apparatus-specific storage device 3. The main module 15 furthermore includes a first communication interface 4a for the wired data transmission of a first communication device 4, which is connected to a communication interface 10 of the mounting device 9 for the purpose of supplying data and/or signals. The communication interface 4a in this instance forms the bidirectional module communication interface 23, illustrated with reference to FIG. 3, of the main module and is used for data transmission to a communication module 19.

The depiction furthermore shows that the testing apparatus 1 includes an energy storage module 30, which is attached upon the mounting device 9 at a distance from the main module 15 and hence not directly to the main module 15. The energy storage module 30 is in this case connected to the communication interface 10 of the mounting device 9 for the purpose of supplying power, this interface 10 being able to be used by an external device 14 to supply power to the energy storage module 30 (see FIG. 2).

The depiction furthermore shows that the testing apparatus 1 includes a communication module 19 that is attached upon the mounting device 9 at a distance from the main module 15 and hence not directly to the main module 15. The communication module 19 forms a communication interface 4b of the first communication device 4 for wireless data transmission.

The depiction furthermore schematically shows power supply lines for supplying power to the main module 15. The submodules 16, 17, 18, and 29 and the communication module 19 can naturally also be supplied with power by the power supply module 30.

The depiction furthermore shows a temperature sensor 31 of the main module 15, which captures an ambient temperature of the main module 15 or a temperature in an interior 41 of the main module 15.

Output signals or output data of the temperature sensor 31 can be stored in the apparatus-specific storage device 3 and for example read by an evaluation device 7 of an external device 5 (see FIG. 1). Alternatively, these signals or data can also be transmitted to the external device 5 directly, e.g., with the first communication device 4.

For example, a system to be tested can then be tested on the basis of the temperature data retrieved in this manner.

The depiction furthermore shows the external device 5, wherein the external device 5 comprises not only the evaluation device 7 (see also FIG. 1, for example) but also a device 32 for RF-based wireless data transmission in accordance with RFID technology and a device 33 for radio-based data transmission between the external device 5 and the testing apparatus 1. In this instance, the communication module 19 of the testing apparatus 1 may be configured to allow both RFID-based data transmission and radio-based data transmission via this communication module 19. In particular, an antenna structure 28 (see FIG. 4, for example) may be configured such that both data of an RFID-based data transmission and data of a radio-based data transmission are transmittable via the antenna structure 28.

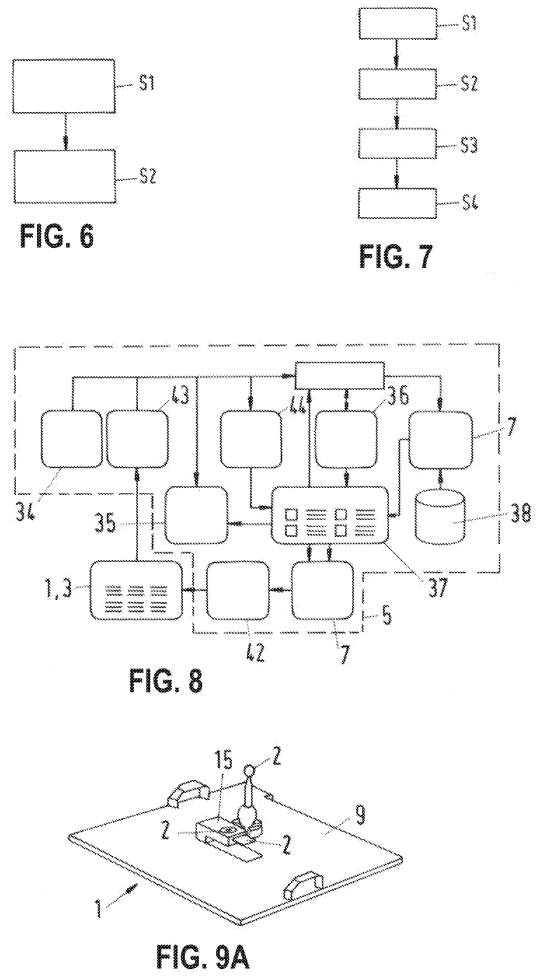

FIG. 6 shows a schematic flowchart of a method for testing an object detection device. In a first step S1, test or calibration data are retrieved from an apparatus-specific storage device 3 of the testing apparatus 1 (see FIG. 1). Furthermore, the testing is then performed on the basis of these retrieved test or calibration data in a second step S2. As explained above, it is also possible for stored output signals or output data of a device for capturing a physical variable, for example the temperature sensor 31 depicted in FIG. 5, to be retrieved in addition to the stored test or calibration data, and for the testing to then be performed additionally on the basis of these retrieved signals/data.

FIG. 7 shows a schematic flowchart of a method according to a further exemplary embodiment of the disclosure. In this instance, module-specific calibration data, which may be stored in module-specific storage devices 21 (see FIG. 3), for example, are retrieved in a first step S1. These calibration data can optionally be transmitted from these module storage devices 21 to the apparatus-specific storage device 3 and stored therein, in which case these module-specific calibration data stored in this manner can then be retrieved by an external device 5 (see FIG. 1, for example). It is likewise possible for the module-specific test or calibration data 21 to be retrieved directly from the module-specific storage devices 21. In this instance, module-specific test or calibration data of the main module 15 may be stored in the apparatus-specific storage device 3, which therefore also forms the module-specific storage device of the main module as a result. Alternatively, module-specific test or calibration data of the main module 15 may be stored in a module storage device (not depicted) of the main module 15, which is different than the apparatus-specific storage device 3.

Furthermore, resultant test or calibration data are then determined in a second step S2, for example by the evaluation device 7, depicted in FIG. 1, of the external device 5. This may require information about a relative bearing between the modules 15, 16, 17, 18, and 29 of the testing apparatus 1 (see FIG. 5, example) to also be provided between module-specific calibration data. This information can be provided with a user input, for example. Alternatively, it is possible for such information to be captured in sensor-based fashion. This has already been illustrated above.

In a third step S3, resultant calibration data of the testing apparatus 1 are then transmitted to the apparatus-specific storage device 3 and will then be stored by the latter. Testing can then be performed in a fourth step S4 on the basis of the apparatus-specific resultant calibration data stored in this way.

FIG. 8 shows a schematic function diagram of a system having a testing apparatus 1 and an external device 5, wherein the external device 5 provides functions of multiple functional modules. These functions in this instance can be provided/performed for example by the evaluation device 7 depicted in FIG. 1 and/or by at least one further computing device, which is different than the evaluation device 7.

The depiction shows the testing apparatus 1 with the apparatus-specific storage device 3 for storing apparatus-specific calibration data.

The depiction furthermore shows an RFID reading module 43 of the external device 5, which can retrieve calibration data stored in the apparatus-specific storage device 3. The depiction furthermore shows a QR code reading module 34, which can capture for example a module identifier in the form of a QR code.

The depiction furthermore shows a visualisation module 35 of the external device 5, which may be for example part of an HMI of the external device 5. Said visualization module can visually present information to a user. By way of example, a virtual representation of the testing apparatus 1, in particular a virtual graphical representation of the different modules 15, 16, 17, 18, and 29 their arrangement relative to one another, can be presented. To this end, the visualization module 35 can access a storage module 37, which is explained in more detail below, and the information stored therein.

The depiction furthermore shows an input module 36 of the external device 5, with which, e.g., information about a relative bearing between different modules 15, 16, 17, 18, and 29 of the testing apparatus 1 can be stipulated with a user input. By way of example, it is possible for a software-assisted association to be made for the relative bearing with a user input, wherein, e.g., a CAD-based input tool can be used. By way of example, it is possible to position virtual, graphical representations of modules 15, 16, 17, 18, and 29 relative to one another virtually in a desired manner with a user input. This bearing information can then be stored in a storage module 37 of the external device 5. The storage module 37 may also store module-specific data, e.g., the calibration data and/or geometric data of different modules 15, 16, 17, 18, and 29. The storage module 37 may also store an identifier of a module 15, 16, 17, 18, and 29 and the association of the identifier with the module-specific data.

Furthermore, the evaluation device 7 illustrated above can then determine resultant calibration data of the testing apparatus 1 defined virtually by a user on the basis of the bearing information, also stipulated in this manner, and/or the data stored in the storage module 37. These calibration data can also be stored in the storage module 37. The evaluation device 7 can therefore provide the function of a system generating module.

The resultant calibration data can then be transmitted to the testing apparatus 1 via an RFID writing module 42 and then stored in the apparatus-specific storage device 3 of this testing apparatus 1.

The depiction furthermore shows a database device 38, for example an SQL database device, which, as an alternative or in addition to storage in the storage module 37, may store module-specific data, in particular calibration data or geometric data, or an identifier of modules 15, 16, 17, 18, and 29. The database device may also store, e.g., manufacturer and/or item origin data. By way of example, the evaluation device 7 can take an identifier read by the QR code reading module 34 as a basis for retrieving such data from the database device 38.

The depiction furthermore shows an interpretation module 44 for interpreting the data retrieved from the apparatus-specific storage device 3 and/or the data stored in the storage module 37 and/or or in the database device 38. By way of example, these data may be formatted according to an international standard using descriptors, wherein the interpretation module allows desired information to be extracted from data available in this format. The interpretation module 44 can also change a data format.

It is conceivable for the resultant calibration data stored in the apparatus-specific storage device 3 to comprise/encode only the module-specific calibration data and information about a relative bearing, that is to say a relative position and/or a relative orientation, between the modules. This allows a storage space requirement for data needing to be stored in the apparatus-specific storage device 3 to be reduced.

Furthermore, the storage module 37 and/or the database device 38, but not the apparatus-specific storage device 3, can be used to store data that allow a three-dimensional representation of the testing apparatus 1, that is to say 3D model data. These data usually have a high storage space requirement.

For the purpose of visualizing a three-dimensional representation of an existing testing apparatus 1, appropriate data can be generated, in particular with the evaluation device 7, as illustrated above, from the resultant calibration data retrieved from the apparatus-specific storage device 3 and can, e.g., be displayed with the visualization module 35.

For the purpose of generating a three-dimensional representation of a testing apparatus 1 desired by the user, such data can be generated with the evaluation device 7 from the module-specific data stored in the database device 38 and/or in the storage module 37 and can, e.g., be displayed with the visualization module 35. The resultant calibration data to be stored can then in turn be generated from these data.

The modules illustrated above may be formed in this instance by devices that allow the respective described module function to be performed. It is naturally conceivable for the module functions of multiple modules to be performed by one device. The modules, in particular the storage module 37 and/or the database storage device 38, may be modules of an ERP system in this instance.

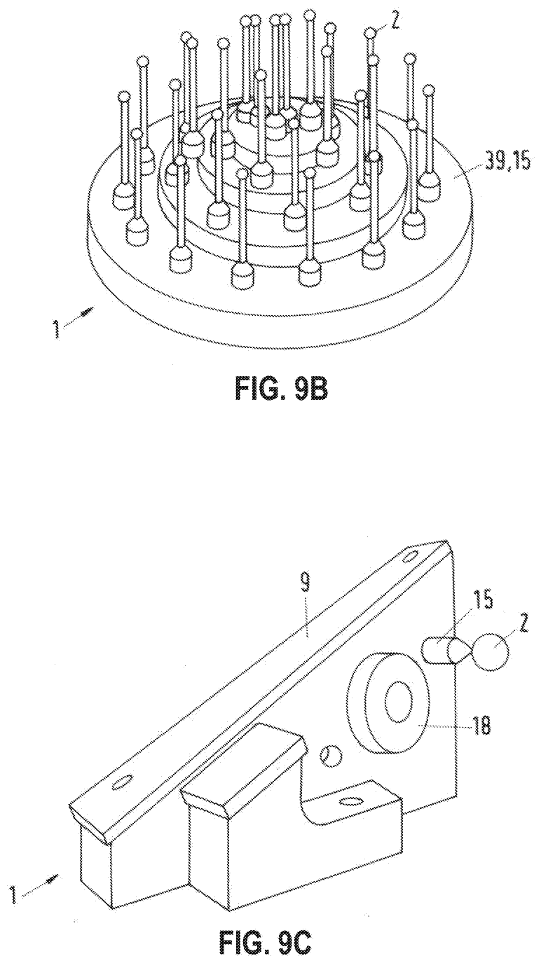

FIG. 9A shows a perspective depiction of a testing apparatus 1 in a first exemplary embodiment. This testing apparatus includes a mounting device 9 in plate-shaped form and a spherical test element 2, an annular test element 2 and a plate-shaped test element 2.

These test elements 2 can be formed by the main module 15. Alternatively, the test elements 2 can also be formed by test element submodules attached to the main module 15.

FIG. 9B shows a perspective view of a testing apparatus 1 in a further exemplary embodiment, this testing apparatus 1 having a plurality of spherical test elements 2 attached to a free end of a rod. The rods in turn are attached to a base body 39 with connecting elements. The base body 39 in this instance may be a base body of the main module 15. For the sake of clarity, only one spherical test element 2 is provided with a reference sign. In this instance, the aggregate of spherical test elements, rods and spherical connecting elements can form a respective test element module of the testing apparatus 1.

FIG. 9C depicts a further exemplary embodiment of a testing apparatus 1. This testing apparatus likewise includes a mounting device 9 on which a spherical test element 2 and, at a distance therefrom, a test element 18 in the form of a gauge ring are arranged. The test element 2 in this instance can be formed by a main module 15. The test element 18 that has or forms the gauge ring may be arranged physically apart from the main module 15 in this instance.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 testing apparatus
2 test element
3 apparatus-specific storage device
4 first communication device
4a first communication interface
4b further communication interface
5 external device
6 communication interface
7 evaluation device
9 mounting device
10 communication interface
11 communication interface
12 further communication interface
13 attachment interface
14 power supply device
15 main module
16 first submodule
17 second submodule
18 third submodule
19 communication module
20 unidirectional module-communication interface
21 module-specific storage device
22 unidirectional module-communication interface
23 bidirectional module-communication interface
24 bidirectional module-communication interface
25 housing
26 attachment interface
27 printed circuit board
28 antenna structure
29 fourth submodule
30 power supply module
31 temperature sensor
32 RFID device
33 device 33 for radio-based data transmission
34 QR code reading module
35 visualization module
36 input module
37 storage module
38 database device
39 base body
40 printed circuit board
41 interior
42 RFID writing module
43 RFID reading module
44 interpretation module
S1 first step
S2 second step
S3 third step
S4 fourth step

What is claimed is:

1. A testing apparatus for testing an object detection device, the testing apparatus having or forming at least one test element, the testing apparatus comprising:
at least one first communication device for data transmission between the testing apparatus and an external device; and
at least one apparatus-specific storage device having apparatus-specific calibration data stored therein or for storing the apparatus-specific calibration data,
wherein stored calibration data are transmittable from the at least one apparatus-specific storage device to the external device via the at least one first communication device, and
wherein the apparatus-specific calibration data to be stored are transmittable to the at least one apparatus-specific storage device via the at least one first communication device.

2. The testing apparatus as claimed in claim 1, further comprising at least one of:
at least one energy storage device,
at least one evaluation device,
at least one capture device for capturing a physical variable, and
at least one information output device.

3. The testing apparatus as claimed in claim 1, further comprising at least one mounting device.

4. The testing apparatus as claimed in claim 1, wherein the at least one first communication device comprises or is in a form of at least one of (a) a device for wireless data transmission and (b) a device for wired data transmission.

5. The testing apparatus as claimed in claim 4, wherein the device for wireless data transmission comprises at least one antenna structure configured both for data transmission in a first frequency range and for data transmission in a further frequency range.

6. The testing apparatus as claimed in claim 1, further comprising:
at least one base body, and
wherein the at least one apparatus-specific storage device is arranged in the at least one base body.

7. The testing apparatus as claimed in claim 5, wherein the at least one antenna structure at least partly covers the at least one apparatus-specific storage device.

8. The testing apparatus as claimed in claim 1, further comprising:
at least two modules, and
wherein one of the at least two modules comprises the at least one apparatus-specific storage device.

9. The testing apparatus as claimed in claim 8, wherein one of the at least two modules comprises a module storage device having at least one of module-specific calibration data and module identifier data stored therein.

10. The testing apparatus as claimed in claim 8, wherein at least one of the at least two modules has or forms at least one attachment device for attaching a further module.

11. The testing apparatus as claimed in claim 8, wherein at least one of the at least two modules comprises at least one communication device for at least one of data and signal transmission between the at least one of the at least two modules and at least one further module.

12. The testing apparatus as claimed in claim 8, wherein one of the at least two modules comprises at least one interface for power transmission to the at least two modules.

13. The testing apparatus as claimed in claim 8, further comprising at least one further module,
wherein the at least one further module is a submodule, and
wherein the submodule is a test element module or an energy storage module or a communication module or an evaluation module or a capture module.

14. A system comprising:
the testing apparatus as claimed in claim 1; and
at least one evaluation device,
wherein resultant calibration data are determinable with the at least one evaluation device based on module-specific calibration data.

15. The system as claimed in claim 14, wherein the system comprises at least one human machine interface (HMI).

16. A method for testing an object detection device, the method comprising:
retrieving calibration data from at least one apparatus-specific storage device of a testing apparatus; and
performing a test based on the calibration data being retrieved.

17. The method as claimed in claim 16, further comprising:
determining and storing resultant calibration data in the at least one apparatus-specific storage device.
